(19) United States
(12) Patent Application Publication
(10) Pub. No.: US 2012/0184471 A1
(43) Pub. Date: Jul. 19, 2012

(54) LUBRICATING VARNISH FOR COATING A METAL COMPONENT OR APPLIED TO A METAL COMPONENT

(75) Inventors: Jurgen Windrich, Leimen (DE); Carsten Duppe, Kumach (DE); Ivan Grozev, Erlangen (DE)

(73) Assignee: Schaeffler Technologies AG & Co. KG, Herzogenaurach (DE)

(21) Appl. No.: 13/496,333

(22) PCT Filed: Sep. 23, 2010
(86) PCT No.: PCT/EP2010/064010

§ 371 Date: Mar. 15, 2012

(30) Foreign Application Priority Data
Sep. 29, 2009 (DE) 10 2009 043 435.6

(51) Int. Cl. C10M 125/02; C10M 125/20; C10M 125/26; C10M 147/02; C10M 125/06; C10M 129/16; C10M 149/12; C10M 131/04; C10M 169/04; C10M 145/40; C10M 129/26; C10M 151/04; C10M 149/08; C10M 143/02; C10M 143/04; C10M 125/10; B82Y 30/00

(52) U.S. Cl. 508/113; 508/165; 508/155; 508/137; 508/181; 508/167; 508/582; 508/551; 508/590; 508/579; 508/110; 508/216; 508/459; 508/480; 508/569; 508/591; 508/172; 977/742

(57) ABSTRACT

Lubricating varnish for coating a metal component or applied to a metal component, including a base coat as a matrix and at least one lubricant. At least one antiwear agent (5) is additionally included.

### FIELD OF THE INVENTION

The present invention relates to a lubricating varnish for coating a metal component or applied to a metal component, made up of a base varnish as a matrix and at least one lubricant.

### BACKGROUND

Lubricating varnishes are known, and have many applications, for example in manufacturing and assembly. They facilitate assembly, support the running of highly loaded machine elements, and in many cases ensure maintenance-free permanent lubrication. In general, lubricating varnishes improve tribological behavior with regard to friction and wear in a large number of material systems or material combinations. Lubricating varnishes, applied using known methods, moreover are used for example to reduce force transmission, for cooling, to dampen vibration, to achieve a sealing effect, and to protect against corrosion of components coated therewith. Such components may for example be tool parts, bearing parts, or other components subject to high stress.

Known lubricating varnish systems are made of PE, PE/PTFE, SiO₂, MoS₂, and other modified systems. The disadvantages of these systems result from their limited resistance to wear, above all in work areas with high surface pressure.

### SUMMARY

The present invention is therefore based on the objective of providing a lubricating varnish having improved tribological properties, in particular with regard to resistance to wear.

According to the present invention, in order to meet this objective a lubricating varnish of the type described above is provided, with said varnish additionally containing at least one antiwear agent.

The lubricating varnish according to the present invention for coating a metal component or applied to a metal component is thus essentially made of a base varnish as a matrix and at least one lubricant, and in addition at least one antiwear agent. The lubricating varnish according to the present invention therefore has improved properties with regard to lubrication and wear protection. The application of the lubricant varnish according to the present invention is very flexible, with the result that the lubricating varnish according to the present invention can be used in a large number of applications, because it improves the lubricant and wear properties of a large variety of material systems or material combinations. Thus, for example in linear guides it can be used to bring about a significant reduction in run-in wear, and through the coating of deflecting units or sealing elements a high reduction of friction can be achieved. In bearings in general, coating with the lubricating varnish according to the present invention can prolong use in corrosive media, such as seawater, by increasing the useful life of the bearing. The lubricating varnish according to the present invention can also advantageously be used in high-temperature applications, in a temperature range of 350-450° C., such as in various engines. However, the lubricating varnish according to the present invention is also an interesting alternative in the area of electric motors, because it can effect an electrical insulation. In screwed connections, the lubricating varnish according to the present invention provides defined frictional coefficients with low dispersion. In principle, there are no limits on the use of the lubricating varnish according to the present invention; it is a universally applicable lubricating varnish. Through the use of the lubricating varnish according to the present invention, other lubricants can be omitted, so that a maintenance-free state can be achieved.

In order to produce the lubricating varnish according to the present invention, a base lacquer, acting as a matrix, is agitated at the highest possible rotational speed using a blade agitator for approximately 15 minutes, with care being taken that no air bubbles are introduced into the lubricating varnish. It is important that no solid particles be deposited on the bottom; if this is still the case, the agitation as described above must be continued until a desired degree of homogenization has been reached. After the homogenization by the agitation process, the lubricant and antiwear agents are introduced into the lubricating varnish in small portions under agitation. The lubricant varnish with added antiwear and lubricant agents is then agitated for a further 15 minutes at a high rotational speed, so that a homogenous appearance without streaks and without foam is achieved. Of course, care is also to be taken that a good dispersion of the antiwear and lubricant agents is present, and that no bottom bodies or other agglomerates have formed. In order to set a desired viscosity of the lubricant varnish according to the present invention, solvents or thinners may be used. The total portion of lubricant and antiwear agent is in the range of from 0.01 to 90 vol. %, relative to the matrix. The lubricating varnish according to the present invention thus always contains at least 10 vol. % base varnish or matrix. This also holds if, in addition to the lubricant and antiwear agents, further additives are present whose use is known in lubricating varnishes, e.g. for thermal stabilization. With regard to the composition, it has turned out to be particularly advantageous if the portion of lubricant is preferably in the range of from 20 to 30 vol. % relative to the matrix.

For a better coupling of the at least one antiwear agent in the matrix, or to the other components of the lubricating varnish, it is possible to modify the antiwear agent in its surface using a surface treatment. For this purpose, in particular a silanization of its surface may be used. For the surface treatment of the antiwear agent, amino alkylalkoxy silanes may be used from the group aminopropyl trimethoxysilane, 3-aminopropyl triethoxysilane, 3-aminopropyl methyl dimethoxy silane, 3-aminopropyl methyl diethoxysilane, and/or N-(2-aminoethyl)-3-aminopropyl trimethoxy silane. The quantity of silane is customarily from 0.05 to 20 wt. %, relative to the portion of antiwear agent. The surface treatment of the antiwear agent preferably takes place in a 0.1-50% solution of silane in distilled water, in which the antiwear agent is added directly into a mixer and is mixed for approximately 10 minutes. The silanes accumulate on the antiwear particle surfaces, and then become bonded thereto. If the modified particles are then used in an aqueous base varnish system, the particles can be brought into the base varnish system in the wet state and then applied. If the particles are to be used in a base varnish system based on solvent, the particles can first be dried, after the silanization, at approximately 80° C., and then introduced into the solvent-based varnish system.

The following is a non-exhaustive list of possible antiwear agents:
Yttrium oxide particles stabilized with zirconium oxide particles,

A colloidal dispersion of hexagonal boron nitride particles in a polytetrafluorethylene cladding (such as CERFLON® (trade name)),

Boron nitride particles, such as COMBAT® (trade name)),

Silicon oxide particles and/or silicon oxide particles surface-modified with a silane,

Wollastonite particles and/or wollastonite particles surface-modified with a silane,

Zirconium oxide particles and/or zirconium oxide particles surface-modified with a silane,

Silicon nitride particles and/or silicon nitride particles surface-modified with a silane,

Aluminum oxide particles and/or aluminum oxide particles surface-modified with a silane,

Zinc oxide particles and/or zinc oxide particles surface-modified with a silane,

Zinc sulfide particles and/or zinc sulfide particles surface-modified with a silane,

Titanium oxide particles and/or titanium oxide particles surface-modified with a silane,

Metal carbide particles and/or metal carbide particles surface-modified with a silane,

Tungsten carbide particles and/or tungsten carbide particles surface-modified with a silane,

Boron carbide particles and/or boron carbide particles surface-modified with a silane,

Titanium carbide particles and/or titanium carbide particles surface-modified with a silane,

Silicon carbide particles and/or silicon carbide particles surface-modified with a silane,

Silicon nitride powder made up of the following components: silicon nitride min. 97.0 wt. %, silicon max. 0.3 wt. %, carbon max. 0.3 wt. %, iron max. 0.1 wt. %.

Fullerenes having sum formulas C60, C70, C76, C80, C82, C84, C86, C90, and C94, particle size 0.5-10 nm,

Carbon nanotubes, particle size 0.5-100 nm,

Carbon fibers, particle size 0.5-350 nm.

Except for the three last-named carbon modifications, the particle sizes of the antiwear agents are preferably in the range of from 0.1 nm-20 μm. The shape of the particles is preferably not round, but rather angular, but care is to be taken that the particles do not have cutting edges. As mentioned, the above list is not exhaustive, and of course any other antiwear agents in particle form may also be used. Of course, a combination of different antiwear agents may also be useful. The portion of round antiwear agents not having cutting edges in a particle mixture that is to be dispersed is between 0.1 and 90 wt. % relative to the overall portion of particles. While it is true that a high portion of round antiwear agent results in a high degree of hardness of the coating, at the same time the overall wear resistance decreases. Therefore, preferably 1-75 wt. % round antiwear agent is used, relative to the overall portion of particles. In particular in the case of lubricating varnishes for sliding bearings, it has turned out that particularly advantageous results can be achieved if 10-50 wt. % of the overall mixture is present in the form of round solid particles. With this mixture ratio, consistently improved properties can be obtained with regard to resistance to wear. The non-uniform antiwear agents are customarily sought from the group of aluminum oxides. Examples include all variants and shapes of corundum [or: aluminum oxide]. Further examples include silicon carbides and boron carbides. The selection of the particles is made according to criteria such as pressure resistance and bonding characteristics in the matrix. An example of a very useful antiwear agent is melted corundum, which in addition to its high degree of hardness is distinguished in that it is available in large quantities and is inexpensive to manufacture. Special corundum is often also used, because it ensures color neutrality of the antiwear particles even in relatively high portions.

As a rule, balls of glass or sintered ceramic are used as round antiwear particles. Depending on the choice of the balls, additional variations can be realized in the relation between wear resistance and bearing capacity. For particular applications, the use of sintered ceramic particles not having cutting edges can also be advantageous. For example, these particles can be used when the hardness of the round antiwear agents is to be further increased in order to make it possible to reduce the portion of irregular, non-uniform antiwear agents while maintaining the same resistance to wear.

In general, the round antiwear agents not having cutting edges are made up essentially of silicon oxide, aluminum oxide, mullite, spinel, or zirconium oxide, or various mixtures thereof. However, other corresponding materials may also be used. The hardness and the pressure or breakage behavior of the round antiwear agents not having cutting edges can be varied using additional modifying components such as sodium oxide, lithium oxide, potassium oxide, iron oxide, titanium oxide, magnesium oxide, calcium oxide, neodymium oxide, lanthanum oxide, cerium oxide, yttrium oxide, and/or boron oxide. Again, this list is not exhaustive.

The following is a non-exhaustive selection of possible lubricants:
Polytetrafluoroethylene powder particles,

Graphite and/or nodular graphite powder particles,

Molybdenum sulfide powder particles,

Perfluorpropylvinylether powder particles,

Polyamideimide powder particles,
Soluble polyamides, e.g. all polyamides and copolyamides soluble in alcohol; particularly advantageous is N-methoxymethylated polyamide catalytically accelerated with organic acids,

Perfluormethylvinylether powder particles,

Ethylene-chlortrifluorethylene powder particles,

Polyvinylidene fluoride powder particles,

Polyphthalamide powder particles,

Polyether ether ketone powder particles.

The lubricants preferably have a particle size in the range from 0.5 nm-20 μm. Of course, as lubricants it is also possible to use combinations of lubricants, such as a combination of polytetrafluorethylene mixed with perfluorpropylvinylether, the mixture preferably containing not less than 15 vol. % polytetrafluorethylene and not less than 0.5 vol. % perfluorpropylvinylether. As mentioned, this list is not complete.

Analogous to the at least one antiwear agent, it is also possible to modify the at least one lubricant with regard to its surface, the surface modification taking place in particular via a silanization. The corresponding method for surface treatment of the lubricant corresponds to that noted above for the antiwear agent.

The base varnish used as a matrix in the lubricating varnish according to the present invention is listed below in its possible variants:
Standard lubricating varnishes (such as Molykote® (trade name), manufactured by Dow Corning, Fluoropan 340 AB (trade name), manufactured by Klüber),

Pure base varnishes for UV-hardened, IR-hardened, NIR-hardened, or radiation-hardened resins, such as acrylic resins, alkyd resins, urethane-modified alkyd resins, polyurethane/acrylate dispersions, or epoxy resins, and mixtures thereof. In the specific case of UV-hardened base varnishes, polyether/polyester acrylates, epoxy acrylates, urethane acrylates, and dual-cure systems may be used.

For thermally hardened and/or radiation-hardened base varnishes, phenol resins, acrylate resins, epoxy resins, polyester resins, melamine resins, aminoplasts, polyurethanes, and mixtures of these components are particularly suitable.

An aqueous polyether ether ketone dispersion.
All polymers named as lubricant systems, such as polytetrafluorethylene, perfluorpropylvinylether, polyamide imide, perfluormethylvinylether, ethylene chlortrifluorethylene, polyvinylidene fluoride, polyphthalamide, polyether ether ketone, and mixtures thereof.
   0.01 to 15 vol. % N-(2-aminoethyl)-3-aminopropyltrimethoxysilane can be mixed in as an additive to the base varnish.

Again, this listing makes no claim to completeness.

Moreover, it is possible for fibers of a fiber material to be contained in the lubricating varnish. These fibers, in particular carbon fibers, have a length of from 0.5-350 nm, but may also have any other length. These fibers may also be surface-modified in a manner corresponding to the above-described embodiments for surface modification.

The layer thickness is to be selected corresponding to the concrete situation of use, but as a rule should not be less than 5-10 μm. As a basic rule, the coating of lubricating varnish is to be applied as thinly as possible.

In a further specific embodiment, the lubricating varnish can sheath a fiber material. Here, the fiber material is preferably drenched in the lubricating varnish. This process, to be understood in the sense of resin impregnation or saturation, acts as an additional reinforcement of the component onto which the lubricating varnish according to the present invention is to be applied.

The following list contains a selection of various fiber materials that can be drenched in the lubricating varnish according to the present invention:
Cellulose fibers, such as viscose, Modal, Lyocell, Cupro, acetate, triacetate, paper fibers, bamboo fibers, Cellulon;

rubber fibers,

asbestos,

basalt,

fibrous gypsum,

cotton, kapok, bast fiber, hemp fiber, jute, linen, ramie, hard fibers, sisal, abacá (manila hemp), hard coco fiber,

organic fibers such as polyester, generally polyethylene terephthalate, polyamide, polyimide, polyamide imide, polyphenylene sulfide, aramide, polyacrylnitrile, polytetrafluorethylene, polyethylene, polypropylene,

inorganic chemical fibers, such as glass fibers, carbon fibers,

metal fibers,

ceramic fibers such as oxidic ceramic fibers (e.g. aluminum oxides, mullites, yttrium oxides), non-oxidic ceramic (e.g. silicon carbide),

carbon nanotubes.

It is also possible for the fiber material to be present in the form of a weave of various fiber materials. Mixed weaves of glass and carbon fibers are for example standard here.

Of course, the fiber material can also be surface-modified, and again a silanization is preferred here.

It is possible for the antiwear agent to be incorporated only close to the surface within a hardened lubricating varnish layer; this is explained in more detail below.

In order to apply the lubricating varnish according to the present invention, classic coating methods may be used such as immersion, painting, spraying, spreading with a doctor blade, electro-immersion methods, electrostatic rotational atomizing, or air atomizing.

It is also possible at first to apply only the base varnish containing the one lubricant, if necessary with an additional added lubricant or lubricant mixture, onto a component, and to apply the powdered antiwear agent onto the base varnish before the hardening of the matrix, for example by blowing or scattering. The matrix should not be hardened until after this has been carried out. This has the result that the antiwear agent is present primarily in the regions close to the surface.

In the following, the above-noted advantages of the lubricating varnish according to the present invention are presented on the basis of examples. Emphasis is placed in particular on the reduction of the dry friction coefficients.

On the basis of a commercial standard lubricating varnish, present as a polyamide-polyimide varnish and designed specifically for coating metallic gliding partners, the reduction of the dry friction coefficients is to be indicated in comparison to the lubricating varnish according to the present invention.

In the standard lubricating varnish used as a base varnish, the components are cross-linked via a temperature increase, so that a friction-optimized surface results that in addition has a very good adhesion to the steel surface. Thus, with this system, after the application of the lubricating varnish onto the steel surface and a subsequent 10-minute drying at room temperature, followed by a 30-minute tempering at 200°, a dry friction coefficient against metal 100 Cr6 of 1.5-2.5 can be obtained.

In the context of a comparative trial, 0.1 vol. % of surface-modified silicon oxide particles is mixed with the polyamide-polyimide varnish as an antiwear agent.

For the surface treatment of the silicon oxide particles, as described above, amino alkyl alkoxysilanes were used from the group aminopropyl trimethoxysilane, 3-aminopropyl triethoxysilane, 3-aminopropyl methyldimethoxysilane, and/or N-(2-aminoethyl)-3-aminopropyl trimethoxysilane. A base varnish modified in this way results in a coating having very good adhesion on the steel test body, such that low dry friction coefficients can be achieved, in the range of less than 1.5, and in some cases even less than 1.0. In addition, improved abrasion resistance was realized.

In a further comparative trial, 0.5 vol. % of the surface-modified silicon oxide particles were added to the polyamide-polyimide varnish as antiwear agent; here a particularly small particle size was used, in the range between 20 and 50 nm. With this composition, in frictional tests dry friction coefficients were measured of between 0.9 and 1.5.

In a further test design, finely distributed lubricant powder is added to the polyamide-polyimide varnish. On the basis of polyether ether ketone powder, it turns out that in particular a mixture of polyether ether ketone with polytetrafluorethylene (where the polytetrafluorethylene can also be substituted by perfluorethylene propylene copolymer) achieves a particularly good effect. Here it is important to use particle sizes smaller than 50 nm. With this composition, after the hardening of the matrix there results a dry friction coefficient in the range of approximately 0.4.

A further embodiment begins from the just-described system of polyamide-polyimide varnish and polyether ether ketone/polytetrafluorethylene particles, and silicon nitride particles are now additionally added to this composition. After hardening of the matrix, this composition displays dry friction coefficients of approximately 0.2-0.3.

In addition, the present invention relates to a component, in particular a sliding or roller bearing component of any type, coated with a hardened lubricating varnish of the type described above.

### BRIEF DESCRIPTION OF THE DRAWINGS

An exemplary embodiment of the present invention is shown in the drawing and is described in more detail below.

FIG. 1 shows a schematic representation of the metal component coated with the lubricating varnish according to the present invention,

FIG. 2 shows an enlarged segment of the lubricating varnish applied onto the metal component according to FIG. 1,

FIG. 3 shows a specific embodiment of a component coated with the lubricating varnish according to the present invention, and

FIG. 4 shows a further specific embodiment of a component coated with the lubricating varnish according to the present invention.

### DETAILED DESCRIPTION OF THE PREFERRED EMBODIMENTS

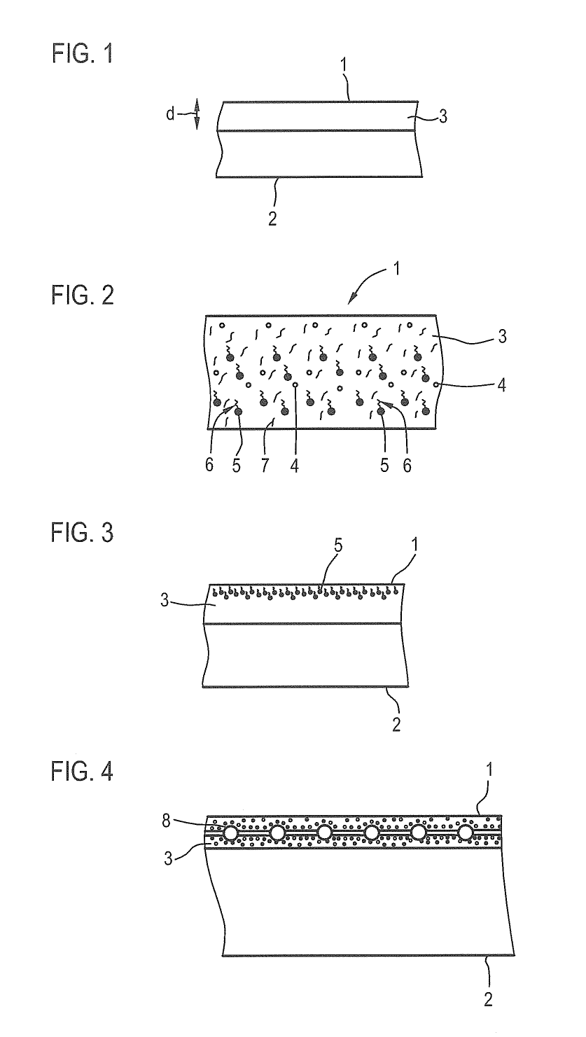

FIG. 1 shows the lubricating varnish 1 according to the present invention in the form of a coating on a component 2, in particular a metal component. Component 2 need not necessarily have a flat surface; rather, it can have any shape, such as bent or angled shapes. In addition, component 2 can have a three-dimensionally structured surface. Thus, the component can deliberately be provided with a certain degree of roughness in order to cause lubricating varnish 1 to adhere even better on the surface of component 2. Between component 2 and lubricating varnish 1 there prevails a stable, preferably non-detachable bond, resulting from the hardening of matrix 3 of lubricating varnish 1. The hardening of matrix 3 can for example take place via a temperature increase, or UV irradiation, NIR irradiation, IR irradiation, or particle irradiation. In this specific embodiment, layer thickness d of lubricating varnish 1 is approximately 25 μm. Due to the application and hardening of lubricating varnish 1, component 2 experiences a significant improvement of its tribological behavior. Thus, for the case in which component 2 is for example a sliding bearing, this sliding bearing will have a significant improvement of its wear and friction properties. For example, through the use of lubricating varnish 1 according to the present invention, component 2 has for example a dry friction coefficient of only 0.2.

FIG. 2 shows an enlarged segment of matrix 3 of lubricating varnish 1 according to the present invention. Matrix 3 contains both finely distributed lubricants 4 and also finely distributed antiwear agents 5. In this embodiment, lubricants 4 are fine polyether ether ketone powder whose particle size is 30 nm. Antiwear agents 5 are surface-modified silicon dioxide having a particle size of approximately 40 nm. The surface modification of antiwear agents 5 takes place via a silanization, where silanes 6, shown as fine lines on antiwear agent 5, bring about a good bonding of antiwear agents 5 in matrix 3 of lubricating varnish 1.

Matrix 3 also contains finely distributed carbon fibers 7, shown in the form of short strokes. Matrix 3 of lubricating varnish 1 further contains additives (not shown here) such as thermal stabilizers or dispersing agents. Given 5 vol. % portion of lubricant 4, the overall portion of antiwear agent 5 is approximately 25 vol. %.

FIG. 3 shows a further specific embodiment of a lubricating varnish 1 applied on a component 2. In matrix 3 of lubricating varnish 1, antiwear agents 5 are mainly present in regions close to the surface; their portion decreases with distance from the surface of the layer of lubricating varnish 1. Thus, there is a decrease in the concentration of antiwear agents 5 going from regions close to the surface to regions further from the surface. This is possible using a specific coating method, according to which first only base varnish containing the one lubricant 4 is applied to the component in the form of matrix 3, containing if warranted a further lubricant 4 or a mixture of lubricants 4, and subsequently antiwear agents 5 are applied onto this still-wet and not yet hardened layer by scattering or blowing. Antiwear agents 5, which are thus applied with a temporal delay, do not migrate through the volume of matrix 3 of lubricating varnish 1, but rather remain in the regions close to the surface. This non-uniform distribution of antiwear agents 5 is also not altered by a hardening of matrix 3.

Here it is possible to first incorporate antiwear agents 5 that may be present in the regions close to the surface, or on the surface, of lubricating varnish 1 into matrix 3 of lubricating varnish 1 during operation, for example by pressing them in.

FIG. 4 shows a further specific embodiment of a component 2 coated with a lubricating varnish 1, in which lubricating varnish 1 is permeated by a three-dimensional fiber structure 8 such as a glass fiber mat. Fiber structure 7 is here sheathed by lubricating varnish 1, and is applied onto component 2 together with lubricating varnish 1. Here it is decisive that first fiber structure 8 is drenched in lubricating varnish 1, so that lubricating varnish 1 is situated around and between the fibers of fiber structure 8. Subsequently, there takes place a wrapping of fiber structure 8, drenched with lubricating varnish 1, onto component 2. The advantage g of the use of fiber structure 8 is that it provides additional reinforcement. In the case of a chemical incompatibility between fiber structure 8 and lubricating varnish 1, or in order to achieve a more stable coupling between fiber structure 8 and lubricating varnish 1, it is possible also to modify the surface of fiber structure 8 by a silanization.

### LIST OF REFERENCE CHARACTERS

1 lubricating varnish
2 component
3 matrix
4 lubricants
5 antiwear agents
6 silanes
7 carbon fibers
8 fiber structure
d layer thickness

1. A lubricating varnish for coating a metal component or applied onto a metal component, comprising a base varnish as a matrix, at least one lubricant, and at least one antiwear agent.

2. The lubricating varnish as recited in claim 1, wherein a sum of the lubricant and the antiwear agent is in range of from 0.01-90 vol. %, relative to the matrix.

3. The lubricating varnish as recited in claim 2, wherein a portion of the lubricant is in a range of from 20-30 vol. %, relative to the matrix.

4. The lubricating varnish as recited in claim 1, wherein the antiwear agent is surface-modified by a silanization.

5. The lubricating varnish as recited in claim 1, wherein the antiwear agent is selected from yttrium oxide, a colloidal dispersion of hexagonal boron nitride in a polytetrafluorethylene cladding, an isoelectric boron nitride compound, a ceramic powder made up of at least 97 wt. % silicon nitride, at most 0.3 wt. % silicon, at most 0.3 wt. % carbon, at most 0.1 wt. % iron, fullerenes, carbon nanotubes, carbon fiber particles, silicon oxide, wollastonite, zirconium oxide, silicon nitride, boron nitride, aluminum oxide, zinc oxide, zinc sulfide, titanium oxide, metal carbides, tungsten carbide, boron carbide, titanium carbide, silicon carbide, or a combination of two or more thereof.

6. The lubricating varnish as recited in claim 1, wherein the lubricant is selected from polytetrafluorethylene, graphite, nodular graphite, molybdenum sulfide, perfluorpropylvinylether, polyamide imide, water-soluble polyamides, water-soluble co-polyamides, perfluormethylvinylether, ethylene chlortrifluorethylene, polyvinylidene fluoride, polyphthalamide, polyether ether ketone, or a combination of two or more thereof.

7. The lubricating varnish as recited in claim 1, wherein the lubricant is surface-modified by a silanization.

8. The lubricating varnish as recited in claim 1, wherein the base varnish is hardenable via a temperature increase, electromagnetic radiation, or particle radiation.

9. The lubricating varnish as recited in claim 1, wherein the lubricating varnish contains fibers of a fiber material.

10. The lubricating varnish as recited in claim 9, wherein the fibers of the fiber material have a length of from 0.5-350 nm.

11. The lubricating varnish as recited in claim 1, wherein the lubricating varnish applied onto the metal component sheathes a fiber material.

12. The lubricating varnish as recited in claim 9, wherein the fiber material is selected from cellulose fibers, viscose, Modal, Lyocell, Cupro, acetate, triacetate, paper fibers, bamboo fibers, Cellulon, rubber fibers, asbestos, cotton, kapok, bast fiber, hemp fiber, jute, linen, ramie, hard fibers, sisal, manila hemp, hard coco fiber, polyester, preferably polyethylene terephthalate, polyamide or polyimide, polyamide imide, polyphenylene sulfide, aramide, polyacrylnitrile, polytetrafluorethylene, polyethylene, polypropylene, glass fibers, carbon fibers, metal fibers based on oxides, including aluminum oxide, mullite, yttrium oxide, or based on non-oxides, carbon nanotubes.

13. The lubricating varnish as recited in claim 12, wherein the fiber material is present in the form of a weave of various fiber materials.

14. The lubricating varnish as recited in claim 13, wherein the fiber material is surface-modified by a silanization.

15. The lubricating varnish as recited in claim 1, wherein the hardened lubricating varnish contains the antiwear agent only in regions close to a surface.

16. A combination of the lubricating varnish according to claim 1 and a component coated with the lubricating varnish which is hardened.

17. The combination of claim 16, wherein the component is a sliding bearing or a roller bearing component.
